(19) United States
(12) Patent Application Publication
(10) Pub. No.: US 2007/0218853 A1
(43) Pub. Date: Sep. 20, 2007

(54) Electronic device with dual antenna structures and their switching method

(75) Inventor: Jen-Huan Yu, Taipei (TW)

Correspondence Address: John G. Chupa;Law Offices of John Chupa & Associates, P.C., Suite 50, 28535 Orchard Lake Road, Farmington Hills, MI, 48334, US

(73) Assignee: COMPAL ELECTRONICS, INC.

(21) Appl. No.: 11/500,216

(22) Filed: Aug. 7, 2006

(30) Foreign Application Priority Data
Mar. 17, 2006 (TW) 095109136

(51) Int. Cl. H04B 7/08; H04B 1/06

(52) U.S. Cl. 455/272; 455/132

(57) ABSTRACT

An electronic device with dual antenna structures comprises a first antenna module for receiving a first transmission signal or a second transmission signal, a first antenna decoding device for decoding the first transmission signal, a second antenna decoding device for decoding the second transmission signal, a controller and a control module, wherein the controller will control the control module to drive the second antenna decoding device to transmit signals by using the second transmission signal as a top priority, if the second transmission signal exists in an environment where the electronic device is located, otherwise the controller will control the control module to drive the first antenna decoding device to transmit signals by using the first transmission signal as a top priority if the second transmission signal does not exist in such environment. Further, the invention also provides a method for switching antennas of the electronic device.

### BACKGROUND OF THE INVENTION

1. Field of the Invention

The present invention relates to an electronic device with dual antenna structures and their switching method, and more particularly to an electronic device with dual antenna structures and their switching method that transmit signals by using two different antenna structures in a single antenna module.

2. Description of the Related Art

In general, the present electronic communication devices capable of receiving two types of wireless transmission signals adopt a switch for switching two different antennas for receiving the wireless transmission signals of different frequencies. R.O.C. Pat. No. 232369 entitled “Method and apparatus of switching antennas for computer wireless network” applied on Nov. 20, 2003 and published on May 11, 2005 comprises: a computer having a base and a screen; an antenna module having a plurality of antennas installed on the screen and coupled to at least one switch; and a control device coupled to the switch and a computer system and driven and controlled by the computer system for selectively switching the antenna module, wherein the antenna module in any screen mode has at least one antenna selected by the control device, so that the selected antenna has a better operating position for the antenna than other unselected antennas. The invention selects an antenna among several antennas installed on the screen for receiving signals, so that a notebook computer can perform with good communications and the wireless signal transmission will not be affected by the mode of the screen.

Further, R.O.C. Pat. No. 241785 entitled “Apparatus and method for antenna signal switching” filed on Aug. 11, 2004 and published on Oct. 11, 2005 comprises: a first antenna for receiving signals; a second antenna for receiving signals; an antenna switch circuit coupled to the first and second antennas, and switching to one of the antennas for receiving signals that enter into the antenna by a switch signal; a signal receiving module for receiving and outputting signals of the antenna switch circuit; and a surge detection module for detecting the existence of a surge after the signal from the signal receiving module is received; if the surge exists, then the selected signal will be reversed and sent to the antenna switch circuit to control the signal to be outputted by another antenna of the two antenna. However, both of the aforementioned patented inventions adopt a switch for switching different antennas, so that the electronic device can receive wireless transmission signals of different frequencies, and such arrangement still needs further improvements.

### SUMMARY OF THE INVENTION

Therefore, it is a primary objective of the present invention to provide an electronic device with dual antenna structures and their switching method that use an antenna module having two different antennas in the signal module, so that the electronic device can receive two different types of transmission signals and reduce the occupied space on the screen and further overcome the shortcoming of producing interferences during the operation of the antenna.

Another objective of the present invention is to provide an antenna module with dual antenna structures that uses two different antennas in an antenna module, so that the electronic device can receive two different types of transmission signals and reduce the occupied space on the screen and further overcome the shortcoming of producing interferences during the operation of the antenna.

To achieve the foregoing objectives, the electronic device with dual antenna structures of the present invention comprises: a first antenna module, for receiving a first transmission signal or a second transmission signal; a second antenna module, for receiving the first transmission signal or the second transmission signal; a first antenna decoding device, coupled to the first antenna module and the second antenna module, for decoding the first transmission signal; a second antenna decoding device, coupled to the first antenna module and the second antenna module, for decoding the second transmission signal; a controller, coupled to the first antenna decoding device and the second antenna decoding device; and a control module, coupled to the controller, the first antenna decoding device and the second antenna decoding device, for receiving a control of the controller, such that if the second transmission signal exists in an environment where the electronic device is located, then the controller will control the control module to drive the second antenna decoding device to perform a wireless transmission by using the second transmission signal as a top priority; if the second transmission signal does not exist in the environment, then the controller will control the control module to drive the first antenna decoding device to perform the wireless transmission by using the first transmission signal.

To achieve the foregoing objectives, the electronic device with dual antenna structures of the present invention comprises: a first antenna module, for receiving a first transmission signal or a second transmission signal; a second antenna module, for receiving the second transmission signal or a third transmission signal; a first antenna decoding device, coupled to the first antenna module and the second antenna module, for decoding the first transmission signal; a second antenna decoding device, coupled to the first antenna module and the second antenna module, for decoding the second transmission signal; a third antenna decoding device, coupled to the second antenna module, for decoding the third transmission signal; a controller, separately coupled to the first antenna decoding device, the second antenna decoding device and the third antenna decoding device; and a control module, for receiving a control of the controller; such that if the second transmission signal exists in an environment where the electronic device is located, then the controller will control the control module to drive the second antenna decoding device to perform a wireless transmission by using the second transmission signal as a top priority, while receiving the third transmission signal; if the second transmission signal does not exist in the environment, then the controller will control the control module to drive the first antenna decoding device to perform a wireless transmission by using the first transmission signal, while receiving the third transmission signal.

To achieve the foregoing objectives, the method for switching antennas when the electronic device with dual antenna structures is turned on according to the present invention, the electronic device comprises a first antenna module, a second antenna module, a first antenna decoding device, a second antenna decoding device, a controller and a control module, wherein the first antenna module and the second antenna module separately have a first antenna and a second antenna, and the method comprises the steps of: turning on the electronic device; using the controller to control the second antenna decoding device and drive the second antenna; using the second antenna for receiving a second transmission signal; the controller determines the existence of the second transmission signal according to the receiving state of the second antenna; if the second transmission signal exists, then the second antenna will be used for transmitting/receiving the second transmission signal; if the second transmission signal does not exist, then the controller will control the first antenna decoding device and drive the first antenna; and using the first antenna for receiving the first transmission signal.

To achieve the foregoing objectives, the method for switching antennas of an electronic device with dual antenna structures of the present invention, the electronic device comprises a first antenna module, a second antenna module, a first antenna decoding device, a second antenna decoding device, a controller and a control module, wherein the first antenna module includes a first antenna and a second antenna, and the second antenna module includes a third antenna and a fourth antenna, and the method comprises the steps of: the electronic device using the first antenna and the third antenna for receiving a first transmission signal; the electronic device receiving a detection instruction; using the controller to turn off the first antenna and turn on the second antenna, and the second antenna decoding device receiving a second transmission signal; the controller determining whether or not the second transmission signal exists in the environment according to the receiving state of the second antenna; if yes, then the control module will turn off the third antenna and turn on the fourth antenna for transmitting/receiving the second transmission signal; using the second antenna and the fourth antenna for transmitting/receiving the second transmission signal; if yes, then the control module will turn off the second antenna decoding device and the second antenna and drive the first antenna; and using the first antenna and the third antenna for receiving the first transmission signal.

To achieve the foregoing objectives, the antenna module having dual antenna structures of the present invention comprises: a first antenna, coupled to a first antenna decoding device, for receiving a first transmission signal; and a second antenna, coupled to a second antenna decoding device, for receiving a second transmission signal; such that if the second transmission signal exists in an environment where the antenna module is located, then the second antenna decoding device will perform a wireless transmission by using the second transmission signal as a top priority; if the second transmission signal does not exist in the environment, then the first antenna decoding device will perform a wireless transmission by using the first transmission signal.

### BRIEF DESCRIPTION OF THE DRAWINGS

FIG. 1 is a schematic block diagram of an electronic device with dual antenna structures according to a preferred embodiment of the present invention;

FIG. 2 is a schematic view of a layout of an electronic device with dual antenna structures of the present invention;

FIG. 3 is a schematic block diagram of an electronic device with dual antenna structures according to another preferred embodiment of the present invention;

FIG. 4 is a flow chart of a method for switching antennas when an electronic device with dual antenna structures is turned on according to a preferred embodiment of the present invention; and

FIG. 5 is a flow chart of a method for switching antennas when an electronic device with dual antenna structures is used according to a preferred embodiment of the present invention.

### DETAILED DESCRIPTION OF THE PREFERRED EMBODIMENTS

The structure, technical measures and effects of the present invention will now be described in more detail hereinafter with reference to the accompanying drawings that show various embodiments of the invention.

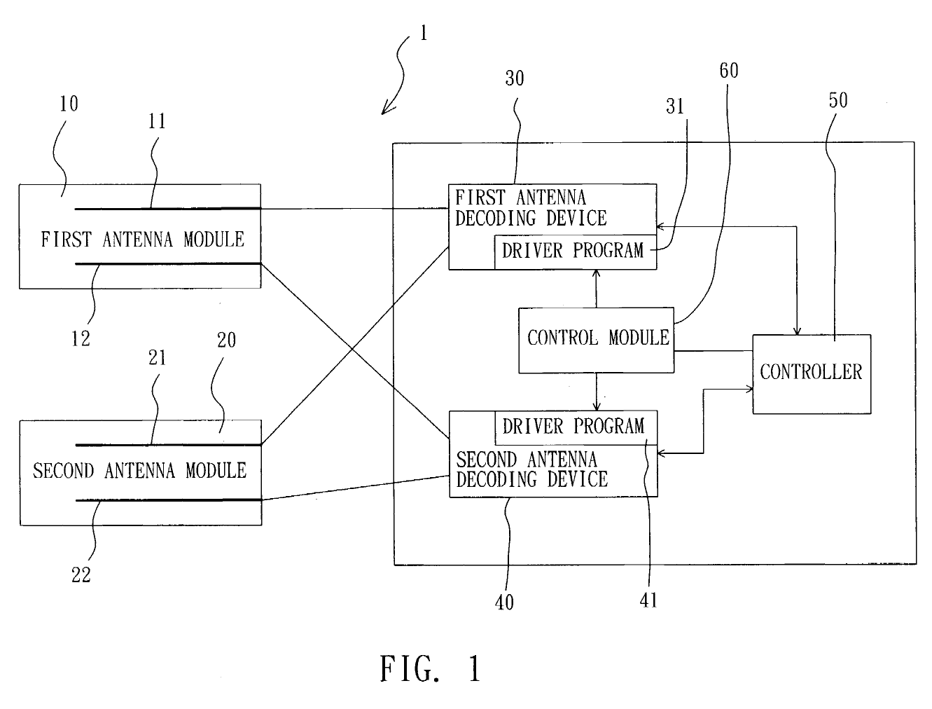

Referring to FIG. 1 for the schematic block diagram of an electronic device with dual antenna structures according to a preferred embodiment of the present invention, the electronic device with dual antenna structures 1 including but not limited to a notebook computer, a desktop computer or a personal digital assistant (PDA) mobile phone comprises: a first antenna module 10; a second antenna module 20; a first antenna decoding device 30; a second antenna decoding device 40; a controller 50; and a control module 60.

The first antenna module 10 is disposed at a side of a screen of the electronic device including but not limited to an upper left corner for receiving a first transmission signal or a second transmission signal, wherein the first transmission signal includes but is not limited to third-generation (3G) mobile phone signal; and the second transmission signal includes but is not limited to a Wi-Fi wireless signal; and the first antenna module 10 can be turned on or off by the first antenna decoding device 30 or the second antenna decoding device 40 for preventing an interference occurred between signals, and the first antenna module 10 further comprises: a first antenna 11 and a second antenna 12; wherein the first antenna 11 is coupled to the first antenna decoding device 30 for transmitting/receiving the first transmission signal, and the second antenna 12 is coupled to the second antenna decoding device 40 for transmitting/receiving the second transmission signal. The first antenna 11 and the second antenna 12 can be packaged into the first antenna module 10 according to the product requirements. Further, the first antenna module 10 is preferably installed at a side including but not limited to an upper left side of a display screen of the electronic device 1.

The second antenna module 20 is disposed on another side including but not limited to the upper right corner of the electronic device for receiving the first transmission signal or the second transmission signal; and the second antenna module 20 is turned on or off by the first antenna decoding device 30 or the second antenna decoding device 40 for preventing an interference occurred between signals. The second antenna module 20 further comprises: a third antenna 21 and a fourth antenna 22; wherein the third antenna 21 is coupled to the first antenna decoding device 30 for transmitting/receiving the first transmission signal, and the fourth antenna 22 is coupled to the second antenna decoding device 40 for transmitting/receiving the second transmission signal. The third antenna 21 and the fourth antenna 22 can be packaged into the second antenna module 20 according to the product requirements. Further, the second antenna module 20 is preferably installed on another side including but not limited to the upper right side of a display screen of the electronic device 1.

The first antenna decoding device 30 is coupled to the first antenna module 10 and the second antenna module 20 for decoding the first transmission signal.

The second antenna decoding device 40 is coupled to the first antenna module 10 and the second antenna module 20, for decoding the second transmission signal.

The controller 50 is coupled to the first antenna decoding device 10, the second antenna decoding device 20 and the control module 30, and the controller 50 includes but is not limited to an embedded controller (EC) which can be switched according to the state of the second transmission signal for selectively switching the first antenna 11 and the third antenna 21 to transmit/receive the first transmission signal or selectively switching the second antenna 12 and the fourth antenna 22 to transmit/receive the second transmission signal, so as to save the transmission cost.

The control module 60 is coupled to the controller 50, the first antenna decoding device 10 and the second antenna decoding device 20 for receiving a control of the controller 50, and the control module 60 is a software module that receives a control of the controller 50 to drive the first antenna decoding device 30 or the second antenna decoding device 40. Further, the first antenna decoding device 30 and the second antenna decoding device 40 separately include a driver program 31, 41 that can receive a control of the software module 60 to drive the first antenna decoding device 30 or the second antenna decoding device 40.

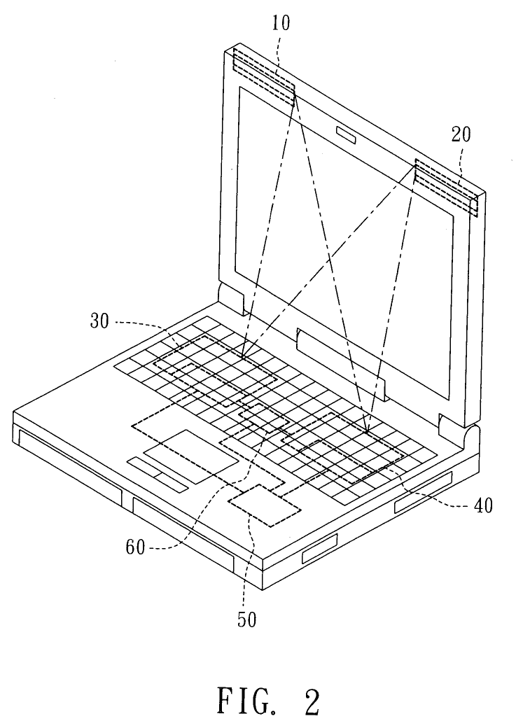

Referring to FIG. 2 for the schematic view of a layout of an electronic device with dual antenna structures according to the present invention, a first antenna module 10 is preferably installed at an upper left side of a display screen of the electronic device 1 and a second antenna module 20 is preferably installed at an upper right side of the display screen of the electronic device 1, and a first antenna decoding device 30, a second antenna decoding device 40, a controller 50 and a control module 60 are disposed in the main body of the electronic device 1. If a second transmission signal exists in an environment where the electronic device 1 is located, then the controller 50 will control the control module 50 to drive the second antenna decoding device 40 to perform a wireless transmission by using the second transmission signal as a top priority, so as to save the transmission cost. If the second transmission signal does not exist in the environment, then the controller 50 will control the control module 60 to drive the first antenna decoding device 30 to perform a wireless transmission by using the first transmission signal. The electronic device with dual antenna structures of the invention uses the first antenna module 10 and the second antenna module 20 of the same structure, not only saving the usable space on the screen of the electronic device 1, but also saving the cost of components. Therefore, the present invention definitely can overcome the shortcomings of the traditional electronic device with dual antenna structures.

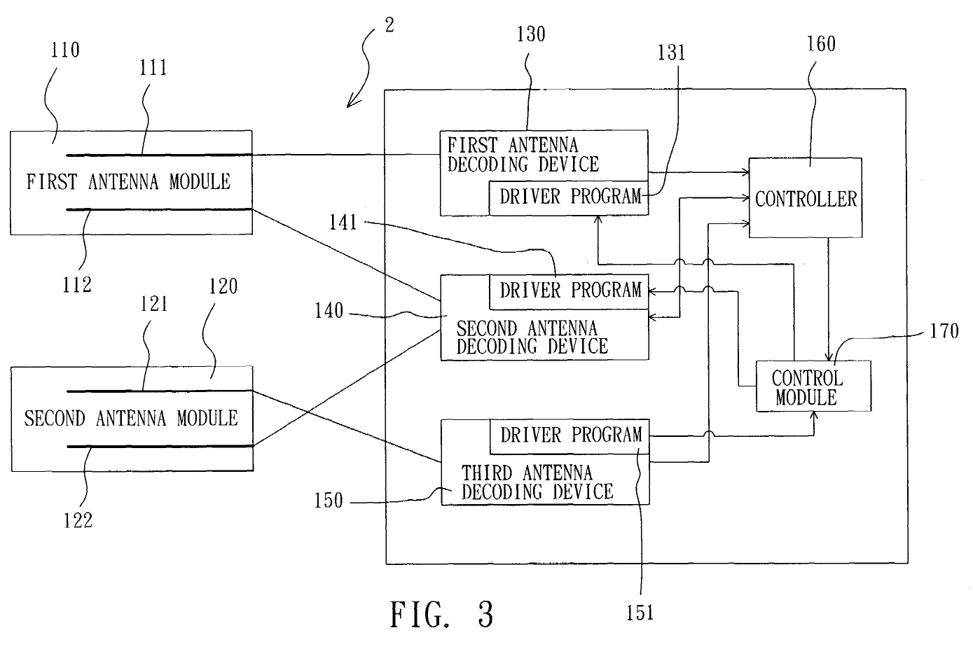

Referring to FIG. 3 for the schematic block diagram of an electronic device with dual antenna structures according to another preferred embodiment of the present invention, the electronic device with dual antenna structures 2 including but not limited to a notebook computer, a desktop computer or a personal digital assistant (PDA) mobile phone comprises: a first antenna module 110; a second antenna module 120; a first antenna decoding device 130; a second antenna decoding device 140; a third antenna decoding device 150; a controller 160; and a control module 170.

The first antenna module 110 is disposed on a side of a screen of the electronic device for receiving a first transmission signal or a second transmission signal, wherein the first transmission signal includes but is not limited to third-generation (3G) mobile phone signal; and the second transmission signal includes but is not limited to a Wi-Fi wireless signal; and the first antenna module 110 can be turned on or off by the first antenna decoding device 130 or the second antenna decoding device 140 for preventing an interference occurred between signals. The first antenna module 110 further comprises: a first antenna 111 and a second antenna 112, wherein the first antenna 111 is coupled to the first antenna decoding device 130 for transmitting/receiving the first transmission signal, and the second antenna 112 is coupled to the second antenna decoding device 140 for transmitting/receiving the second transmission signal. Further, the first antenna module 110 is preferably installed at a side including but not limited to an upper left side of a display screen of the electronic device 2.

The second antenna module 120 is disposed at another side of a screen of the electronic device for receiving the second transmission signal or a third transmission signal, wherein the third transmission signal includes but is not limited to an analog or digital television wireless signal; and the second antenna module 120 can be turned on or off by the second antenna decoding device 140 or the third antenna decoding device 150 for preventing an interference occurred between signals. The second antenna module 120 further comprises: a third antenna 121 and a fourth antenna 122, wherein the third antenna 121 is coupled to the third antenna decoding device 150 for transmitting/receiving the third transmission signal, and the fourth antenna 122 is coupled to the second antenna decoding device 140 for transmitting/receiving the second transmission signal. Further, the second antenna module 120 is preferably installed at another side including but not limited to the upper right side of a display screen of the electronic device 2.

The first antenna decoding device 130 is coupled to the first antenna module 110 for decoding the first transmission signal.

The second antenna decoding device 140 is coupled to the first antenna module 110 and the second antenna module 120 for decoding the second transmission signal.

The third antenna decoding device 150 is coupled to the second antenna module 120 for decoding the third transmission signal.

The controller 160 is coupled to the first antenna decoding device 110, the second antenna decoding device 120, the third antenna decoding device 150 and the control module 170, and the controller 160 includes but is not limited to an embedded controller (EC) and can be used for switching to the first antenna 111 according to the state of the second transmission signal to transmit/receive the first transmission signal, while the fourth antenna 122 is used for receiving the third transmission signal or using the second antenna 112 and the fourth antenna 122 to transmit/receive the second transmission signal, while the fourth antenna 122 is used for receiving the third transmission signal, so as to save the transmission cost.

The control module 170 can receive a control of the controller 160, and the control module 170 is a software module capable of receiving a control of the controller 160 to drive the first antenna decoding device 130, the second antenna decoding device 140 or the third antenna decoding device 150. Further, the first antenna decoding device 130, the second antenna decoding device 140 and the third antenna decoding device 150 separately include a driver program 131, 141, 151 capable of receiving a control of the software module 170 to drive the first antenna decoding device 130, the second antenna decoding device 140 or the third antenna decoding device 150.

If the second transmission signal exists in an environment where the electronic device 2 is located during an application, then the controller 160 will control the control module 170 to drive the second antenna decoding device 140 to perform a wireless transmission by using the second transmission signal as a top priority, while the fourth antenna 122 is used for receiving the third transmission signal, so as to save the transmission cost. If the second transmission signal does not exist in the environment, then the controller 160 will control the control module 170 to drive the first antenna decoding device 130 to perform a wireless transmission by using the first transmission signal as a priority, while the fourth antenna 122 is used for receiving the third transmission signal. The electronic device with dual antenna structures 2 of the invention uses a first antenna module 110 and a second antenna module 120 of the same structure, not only saving the usable space of a display screen of the electronic device 2, but also saving the cost of components. Further, the invention also has a function of receiving an analog or digital television wireless signal, and thus definitely can overcome the shortcomings of the traditional electronic device with dual antenna structures.

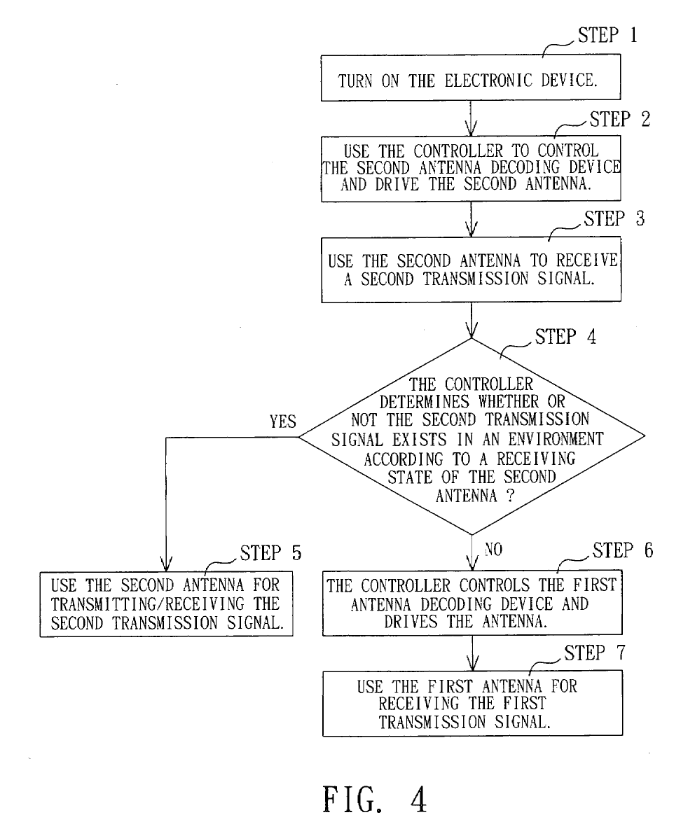

Referring to FIG. 4 for the flow chart of a method for switching antennas when an electronic device with dual antenna structures 1 is turned on according to a preferred embodiment of the present invention, the electronic device 1 comprises a first antenna module 10, a second antenna module 20, a first antenna decoding device 30, a second antenna decoding device 40, a controller 50 and a control module 60, wherein the first antenna module 10 and the second antenna module 20 separately include a first antenna 11, 21 and a second antenna 12, 22, and the method comprises the steps of: turning on the electronic device 1 (Step 1); using the controller 50 to control the second antenna decoding device 20 to drive the second antenna 22 (Step 2); using the second antenna 22 to receive a second transmission signal (Step 3); the controller 50 determines whether or not the second transmission signal exists in an environment according to a receiving state of the second antenna 22 (Step 4); if yes, then the second antenna 22 will be used for transmitting/receiving the second transmission signal (Step 5); if no, then the controller 50 will control the first antenna decoding device 30 to drive the first antenna 11 (Step 6); and using the first antenna 11 for receiving the first transmission signal (Step 7).

In Steps 1 to 3, the electronic device 1 uses the controller 50 to control the second antenna decoding device 20 and drive the second antenna 22 when the electronic device 1 is turn on, so that the second antenna 22 can be used for receiving the second transmission signal. The aforementioned second transmission signal is a Wi-Fi wireless signal.

In Step 4, the controller 50 determines whether or not the second transmission signal exists in an environment according to a receiving state of the second antenna 22; wherein the controller 50 determines whether or not the second transmission signal exists in an environment according to intensity (RSSI) of the second transmission signal, and the controller 50 can automatically detect the state of the second transmission signal for an interval of specific time period including but not limited to several seconds, or a press button (not shown in the figure) is used to trigger the controller 50 to detect the state of the second transmission signal.

In Step 5, if the second transmission signal does not exist in the environment where the electronic device 1 is located, then the electronic device 1 will start using the second antenna 22 to transmit/receive the second transmission signal, so as to save the transmission cost.

In Steps 6 and 7, if the second transmission signal does not exist in the environment where the electronic device 1 is located or the intensity of the second transmission signal is not large enough, then the controller 50 will control the first antenna decoding device 30 to drive the first antenna 11 and use the first antenna 11 for receiving the first transmission signal. With the aforementioned method of switching antennas for the electronic device 1 when the electronic device 1 is turned on, a stable switch between the first transmission signal and the second transmission signal can be achieve to save the transmission cost.

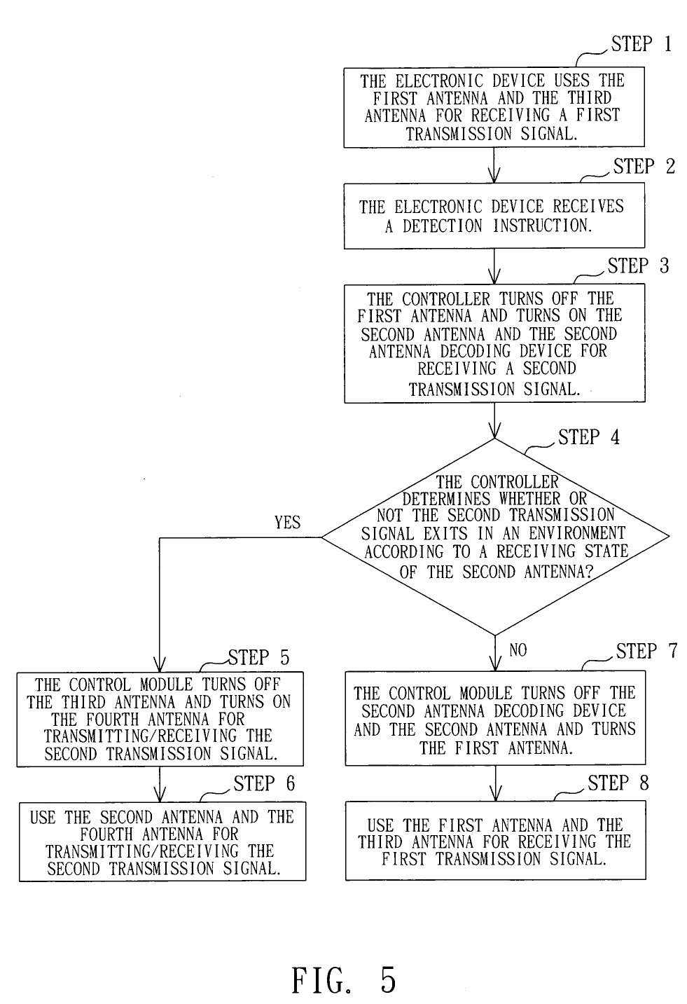

Referring to FIG. 5 for the flow chart of a method for switching antennas when an electronic device with dual antenna structures is used according to a preferred embodiment of the present invention, the electronic device 1 comprises a first antenna module 10, a second antenna module 20, a first antenna decoding device 30, a second antenna decoding device 40, a controller 50 and a control module 60, wherein the first antenna module 10 includes a first antenna 11 and a second antenna 12, and the second antenna module 20 includes a third antenna 21 and a fourth antenna 22, and the method comprises the steps of: the electronic device 1 using the first antenna 11 and the third antenna 21 to receive a first transmission signal (Step 1); the electronic device 1 receiving a detection instruction (Step 2); using the controller 50 to turn off the first antenna 11 and turn on the second antenna 12 and the second antenna decoding device 40 for receiving a second transmission signal (Step 3); the controller 50 determining whether or not the second transmission signal exists in an environment according to a receiving state of the second antenna 12 (Step 4); if yes, the control module 60 will turn off the third antenna 21 and turn on the fourth antenna 22 for transmitting/receiving the second transmission signal (Step 5); using the second antenna 12 and the fourth antenna 22 to transmit/receive the second transmission signal (Step 6); if no, then the control module 60 will turn off the second antenna decoding device 40 and the second antenna 12 and drive the first antenna 11 (Step 7); and using the first antenna 11 and the third antenna 21 to receive the first transmission signal (Step 8).

In Step 1, the electronic device 1 uses the first antenna 11 and the third antenna 21 for receiving a first transmission signal. The aforementioned first transmission signal is a 3G wireless signal.

In Step 2, the electronic device 1 receives a detection instruction. The aforementioned first transmission signal is a 3G wireless signal, and the detection instruction can be generated automatically for every interval of a specific time period including but not limited to several seconds or generated manually by triggering a press button (not shown in the figure).

In Step 3, the electronic device 1 uses the controller 50 to turn off the first antenna 11 and turn on the second antenna 12 and the second antenna decoding device 40 and get ready for receiving a second transmission signal. The aforementioned second transmission signal is a Wi-Fi wireless signal.

In Step 4, the controller 50 determines whether or not the second transmission signal exists in an environment according to a receiving state of the second antenna 12; wherein the controller 50 determines the existence of the second transmission signal according to the intensity (RSSI) of the second transmission signal.

In Steps 5 and 6, if the second transmission signal exists in an environment where the electronic device 1 is located, then the control module 60 will turn off the third antenna 21 and turn on the fourth antenna 22, and use the second antenna 12 and the fourth antenna 22 for transmitting/receiving the second transmission signal, so as to save the transmission cost.

In Steps 7 and 8, if the second transmission signal does not exist in an environment where the electronic device 1 is located, or the intensity of the second transmission signal is not large enough, then the control module 60 will turn off the second antenna decoding device 40 and the second antenna 12 and drive the first antenna 11 and use the first antenna 11 and the third antenna 21 for receiving the first transmission signal. Therefore, the foregoing method for switching antennas can be used for stably switching between the first transmission signal and the second transmission signal when the method is used in the electronic device 1, so as to save the transmission cost.

Further, the present invention also provides an antenna module with dual antenna structures 10 that uses two different antennas in the antenna module, so that the electronic device can receive two different types of transmission signals and reduce the usable space on the screen of the antenna module for preventing interferences occurred during the operation of the antenna. The antenna module 10 comprises: a first antenna 11 coupled to a first antenna decoding device 30, for receiving a first transmission signal; and a second antenna 12 coupled to a second antenna decoding device 40, for receiving a second transmission signal; such that if the second transmission signal exists in an environment where the antenna module 10 is located, then the second antenna decoding device 40 will perform a wireless transmission by using the second transmission signal as a top priority; if the second transmission signal does not exist in the environment, then the first antenna decoding device 30 will use the first transmission signal to perform a wireless transmission. The antenna module 10 is disposed on a side of a screen of an electronic device and can be turned on or off by the first antenna decoding device 30 or the second antenna decoding device 40 for preventing an interference occurred between signals. Further, the first transmission signal includes but is not limited to a 3G mobile phone signal; and the second transmission signal includes but is not limited to a Wi-Fi wireless signal.

Therefore, the method for switching antennas of the present invention can be used for stably switching between the first transmission signal and the second transmission signal when the electronic device 1 is turned on, so as to save the transmission cost. The present invention definitely can overcome the shortcomings of the traditional electronic device with dual antenna structures.

The present invention provides a feasible solution and improves over the prior art, and an application of this invention is duly filed accordingly. However, it is to be noted that the preferred embodiments disclosed in the specification and the accompanying drawings are not intended to limit the invention. To the contrary, it is intended to cover various modifications and similar arrangements and procedures, and thus the scope of the appended claims should be accorded the broadest interpretation so as to encompass all such modifications and similar arrangements and procedures.

What is claimed is:

1. An electronic device with dual antenna structures, comprising:
an antenna module, disposed on a screen and having a first antenna and a second antenna for receiving a first transmission signal and a second transmission signal, and said first antenna and said second antenna being packaged in said antenna module, and said first antenna receiving said first transmission signal, and said second antenna receiving said second transmission signal;
a first antenna decoding device, coupled to the first antenna, for controlling said first antenna and decoding said first transmission signal;
a second antenna decoding device, coupled to the second antenna, for controlling said second antenna and decoding said second transmission signal;
a controller, coupled to said first antenna decoding device and said second antenna decoding device; and
a control module, coupled to said controller, said first antenna decoding device and said second antenna decoding device, for receiving a control of said controller.

2. The electronic device of claim 1, wherein said first transmission signal is a third-generation (3G) mobile phone signal, and said second transmission signal is a Wi-Fi wireless signal.

3. The electronic device of claim 1, wherein said control module is a software module for receiving a control of said software module to drive said first antenna decoding device or said second antenna decoding device.

4. The electronic device of claim 3, wherein said first antenna decoding device and said second antenna decoding device separately include a driver program for receiving a control of said software module and driving said first antenna decoding device or said second antenna decoding device.

5. The electronic device of claim 1, wherein said, wherein said controller is an embedded controller.

6. An electronic device with dual antenna structures, comprising:
a first antenna module, for receiving a first transmission signal and a second transmission signal;
a second antenna module, for receiving said second transmission signal and a third transmission signal;
a first antenna decoding device, coupled to said first antenna module and said second antenna module, for decoding said first transmission signal;
a second antenna decoding device, coupled to said first antenna module and said second antenna module, for decoding said second transmission signal;
a third antenna decoding device, coupled to said second antenna module, for decoding said third transmission signal;
a controller, coupled separately to said first antenna decoding device, said second antenna decoding device and said third antenna decoding device; and
a control module, for receiving a control of said controller;
thereby, when said second transmission signal exists in an environment where said electronic device is located, then said controller will control said control module to drive said second antenna decoding device to perform a wireless transmission by using said second transmission signal as a top priority while receiving said third transmission signal; when said second transmission signal does not exist in said environment, then said controller will control said control module to drive said first antenna decoding device to perform a wireless transmission by using said first transmission signal as a top priority while receiving said third transmission signal.

7. The electronic device of claim 6, wherein said first transmission signal is a third-generation (3G) mobile phone signal, said second transmission signal is a Wi-Fi wireless signal, and said third transmission signal is an analog or digital television wireless signal.

8. The electronic device of claim 6, wherein said first antenna module is disposed on a side of a screen of said electronic device and turned on or off by said first antenna decoding device or said second antenna decoding device for preventing an interference between signals, and said first antenna module further comprises a first antenna and a second antenna; and said first antenna is coupled to said first antenna decoding device for transmitting/receiving said first transmission signal, and said second antenna is coupled to said second antenna decoding device for transmitting/receiving said second transmission signal.

9. The electronic device of claim 6, wherein said second antenna module is disposed on another side of a screen of said electronic device and turned on or off by said first and second antenna decoding device or said third antenna decoding device for preventing an interference between signals, and said second antenna module further comprises further comprises a third antenna and a fourth antenna; and said third antenna is coupled to said third antenna decoding device for transmitting/receiving said third transmission signal, and said fourth antenna is coupled to said second antenna decoding device for transmitting/receiving said second transmission signal.

10. The electronic device of claim 6, wherein said control module is a software module for receiving a control of said controller to drive said first antenna decoding device, said second antenna decoding device or said third antenna decoding device.

11. The electronic device of claim 10, wherein said first antenna decoding device, said second antenna decoding device and said third antenna decoding device separately include a driver program for receiving a control of said software module to drive said first antenna decoding device, said second antenna decoding device or said third antenna decoding device.

12. A method for switching antennas when an electronic device with dual antenna structures is turned on, and said electronic device includes a first antenna module, a second antenna module, a first antenna decoding device, a second antenna decoding device, a controller and a control module, and said first antenna module and said second antenna module separately includes a first antenna and a second antenna, and said method comprising the steps of:
turning on said electronic device;
using said controller to control said second antenna decoding device and drive said second antenna;
using said second antenna to receive a second transmission signal;
said controller determining whether or not said second transmission signal exists in said environment according to a receiving state of said second antenna;
when said second transmission signal is in said environment, said second antenna is used to transmit/receive said second transmission signal;
when said second transmission signal is not in said environment, said controller is used to control said first antenna decoding device and drive said first antenna; and
using said first antenna to receive said first transmission signal.

13. The method for switching antennas of claim 12, wherein said first transmission signal is a third-generation (3G) mobile phone signal, and said second transmission signal is a Wi-Fi wireless signal.

14. The method for switching antennas of claim 12, wherein said controller determines whether or not said second transmission signal exists in an environment according to the intensity of said second transmission signal.

15. The method for switching antennas of claim 12, wherein said controller detects a state of said second transmission signal after a specific time period, or said controller is triggered by pressing a press button to detect a state of said second transmission signal.

16. The method for switching antennas of claim 14, wherein said specific time period is several seconds.

17. A method for switching antennas of an electronic device with dual antenna structures, and said electronic device comprises a first antenna module, a second antenna module, a first antenna decoding device, a second antenna decoding device, a controller and a control module, and said first antenna module includes a first antenna and a second antenna, and said second antenna module includes a third antenna and a fourth antenna, and said method comprising the steps of:
said electronic device using said first antenna and said third antenna for receiving a first transmission signal;
said electronic device receiving a detection instruction;
using said controller to turn off said first antenna and turn on said second antenna and said second antenna decoding device for receiving a second transmission signal;
said controller determine whether or not said second transmission signal exists in an environment according to a receiving state of said second antenna;
when said second transmission signal is in said environment, said control module is used to turn off said third antenna and turn on said fourth antenna to transmit/receive said second transmission signal;
using said second antenna and said fourth antenna to transmit/receive said second transmission signal;
when said second transmission signal is in said environment, said control module is used to turn off said second antenna decoding device and said second antenna and drive said first antenna; and
using said first antenna and said third antenna for receiving said first transmission signal.

18. The method for switching antennas of claim 17, wherein said electronic device is a notebook computer, a desktop computer or a personal digital assistant (PDA) mobile phone.

19. The method for switching antennas of claim 17, wherein said first transmission signal is a third-generation (3G) mobile phone signal, and said second transmission signal is a Wi-Fi wireless signal.

20. The method for switching antennas of claim 17, wherein said controller determines whether or not said second transmission signal exists in an environment according to the intensity of said second transmission signal.

21. The method for switching antennas of claim 17, wherein said detection instruction is generated automatically after a specific time period or generated manually.

22. The method for switching antennas of claim 17, wherein said specific time period is several seconds and said detection instruction is generated manually by pressing a press button.
